(19) United States
(12) Patent Application Publication
(10) Pub. No.: US 2018/0203110 A1
(43) Pub. Date: Jul. 19, 2018

(54) COVER MEMBER OF SENSOR CONFIGURED TO DETECT AMBIENT SITUATION OF VEHICLE AND SENSOR ASSEMBLY

(71) Applicant: HONDA MOTOR CO., LTD., Tokyo (JP)

(72) Inventor: Takato Watanabe, Wako-shi (JP)

(21) Appl. No.: 15/852,434

(22) Filed: Dec. 22, 2017

(30) Foreign Application Priority Data
Jan. 13, 2017 (JP) 2017-004574

(51) Int. Cl. G01S 13/93; G01S 7/03; H01Q 1/22; H01Q 13/02; B60R 19/03; G08G 1/16

(52) U.S. Cl. CPC G01S 13/931; G01S 7/03; G08G 1/16; H01Q 13/02; B60R 19/03; H01Q 1/22

(57) ABSTRACT

There is provided a cover member that protects a sensor configured to output an electromagnetic wave and detect an ambient situation of a vehicle. The cover member includes a cover arranged on the side of the electromagnetic wave output surface of the sensor and formed by a flexible member, and an electromagnetic wave absorbing member attached to the inner surface side or outer surface side of the cover through which the electromagnetic wave output from the sensor passes. The cover and the electromagnetic wave absorbing member form a layer structure.

### CROSS-REFERENCE TO RELATED APPLICATION

This application is based upon and claims the benefit of priority from the prior Japanese Patent Application No. 2017-004574, filed on Jan. 13, 2017, the entire contents of which are incorporated herein by reference.

### BACKGROUND OF THE INVENTION

### Field of the Invention

The present invention relates to a cover member of a sensor configured to detect the ambient situation of a vehicle and a sensor assembly.

### Description of the Related Art

To implement automatic driving or a driving support system, a sensor configured to detect the ambient situation of a vehicle is indispensable. Examples of such a sensor are a radar and a laser scanner (LIDAR), which irradiate the outside of a vehicle with an electromagnetic wave or a laser beam and detect a wave reflected by an object that exists on the periphery of the vehicle. These sensors need to have high accuracy to correctly recognize the ambient situation of the vehicle. If a reflected wave from an unintended direction is received, the accuracy of the sensors lowers.

Japanese Patent Laid-Open No. 2015-212705 proposes preventing a road structure from being erroneously detected as a target by shielding a reflected wave that returns from the road structure on a side of a vehicle as some components of a wave transmitted from a radar device reach the road structure. More specifically, there is proposed covering the both of the left and right side surfaces of a radar device with flat resin plates and extending electromagnetic wave absorbing members from the flat resin plates to a rear bumper.

According to Japanese Patent Laid-Open No. 2015-212705, the flat resin plates are provided on both side surfaces of the radar device. For this reason, a disturbance wave may enter the radar device via the flat resin plates, or a strong reflected wave may be generated by the flat resin plates and enter the radar device. In addition, the cover members of radar devices provided at the four corners of a vehicle readily break even in light collision. This is because the areas of the four corners of the vehicle are small, and a force from a collision object cannot sufficiently be dispersed. In particular, the flat resin plate according to Japanese Patent Laid-Open No. 2015-212705 is pressed against the back surface of the bumper together with the electromagnetic wave absorbing member, and the cover member of the radar device readily break.

### SUMMARY OF THE INVENTION

The present invention provides a cover member that hardly damages a sensor while improving the accuracy of the sensor configured to detect the ambient situation of a vehicle.

The present invention provides a cover member comprising: a cover arranged on a side of an electromagnetic wave output surface of a sensor configured to output an electromagnetic wave and detect an ambient situation of a vehicle and formed by a flexible member; and an electromagnetic wave absorbing member attached to one of a side of an inner surface and a side of an outer surface of the cover through which the electromagnetic wave output from the sensor passes, wherein the cover and the electromagnetic wave absorbing member form a layer structure.

The present invention provides a sensor assembly comprising: a sensor configured to output an electromagnetic wave and detect an ambient situation of a vehicle; and a cover member configured to protect the sensor, wherein the cover member comprises: a cover arranged on a side of an electromagnetic wave output surface of the sensor and formed by a flexible member; and an electromagnetic wave absorbing member attached to a side of an inner surface of the cover through which the electromagnetic wave output from the sensor passes, wherein the cover and the electromagnetic wave absorbing member form a layer structure.

The present invention provides a cover member comprising: a cover arranged on a side of an electromagnetic wave output surface of a sensor configured to output an electromagnetic wave and detect an ambient situation of a vehicle and formed by a flexible member; and an electromagnetic wave absorbing member attached to a range except an irradiation range of the electromagnetic wave in a bumper of the vehicle that covers the cover through which the electromagnetic wave output from the sensor passes, wherein the bumper and the electromagnetic wave absorbing member form a layer structure.

### BRIEF DESCRIPTION OF THE DRAWINGS

FIG. 1 is a schematic plan view of a vehicle;

FIG. 2 is a schematic cross-sectional view showing a sensor assembly;

FIG. 3 is a view showing a cover;

FIG. 4 is a view showing a cover member;

FIG. 5 is a front view showing a sensor;

FIG. 6 is a view for explaining multipath propagation of electromagnetic waves; and

FIG. 7 is a view for explaining electromagnetic wave absorbing members provided in a bumper.

### DESCRIPTION OF THE EMBODIMENTS

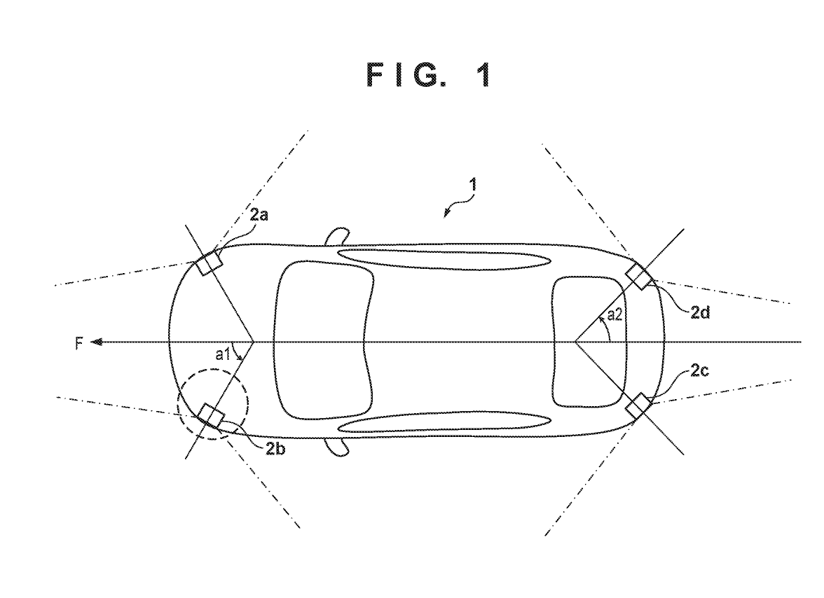

FIG. 1 is a plan view showing a vehicle 1 when viewed from the upper side. An arrow F indicates the traveling direction of the vehicle 1. In this example, sensors 2a, 2b, 2c, and 2d are arranged at the four corners of the vehicle 1. In an explanation of matters common to the sensors 2a, 2b, 2c, and 2d, the characters a, b, c, and d will be omitted, and the sensors will be referred to as sensors 2. The same rule applies to reference numerals added to other members. The sensor 2 is a sensor configured to output an electromagnetic wave and detect the ambient situation of the vehicle. For example, the sensor 2 is a millimeter-wave radar using a millimeter wave or a laser scanner (LIDAR) using a laser beam. To detect the ambient situation of the vehicle 1, the sensors 2 are fixed to the vehicle 1 within the range making a predetermined angle with respect to the traveling direction of the vehicle 1. For example, angles a1 and a2 made by the normals to the electromagnetic wave output surfaces of the sensors 2 and the traveling direction of the vehicle 1 are angles from 40° to 80°. Particularly, the angle a1 made by the normal to the electromagnetic wave output surface of each of the sensors 2a and 2b arranged in the front bumper of the vehicle 1 and the traveling direction of the vehicle 1 is an angle from 60° to 80°. In addition, the angle a2 made by the normal to the electromagnetic wave output surface of each of the sensors 2c and 2d arranged in the rear bumper of the vehicle 1 and the traveling direction of the vehicle 1 is about 40°. Note that the ambient situation detection ranges of the sensors 2a, 2b, 2c, and 2d are ranges indicated by the alternate long and short dashed lines.

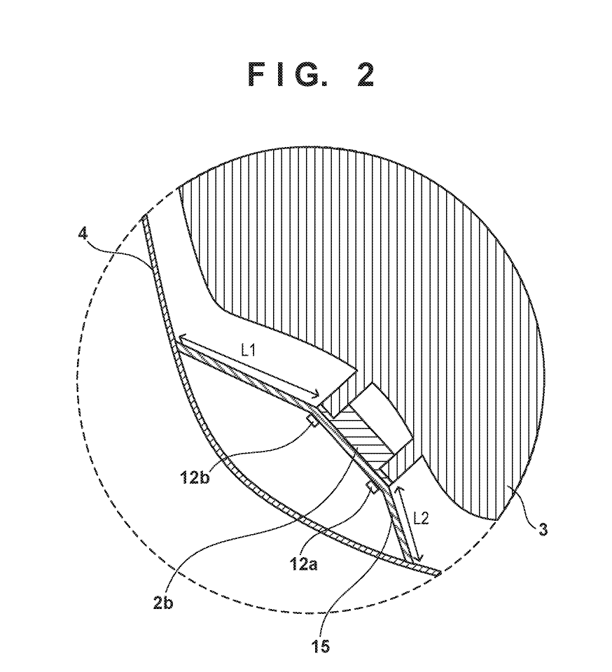

FIG. 2 shows a sensor assembly arranged on the left front side of the vehicle 1. The sensor assembly includes the sensor 2 and a cover member 15. The sensor 2 and the cover member 15 are fixed to a structure 3 of the vehicle 1 by fixing members 12a and 12b such as screws or clips.

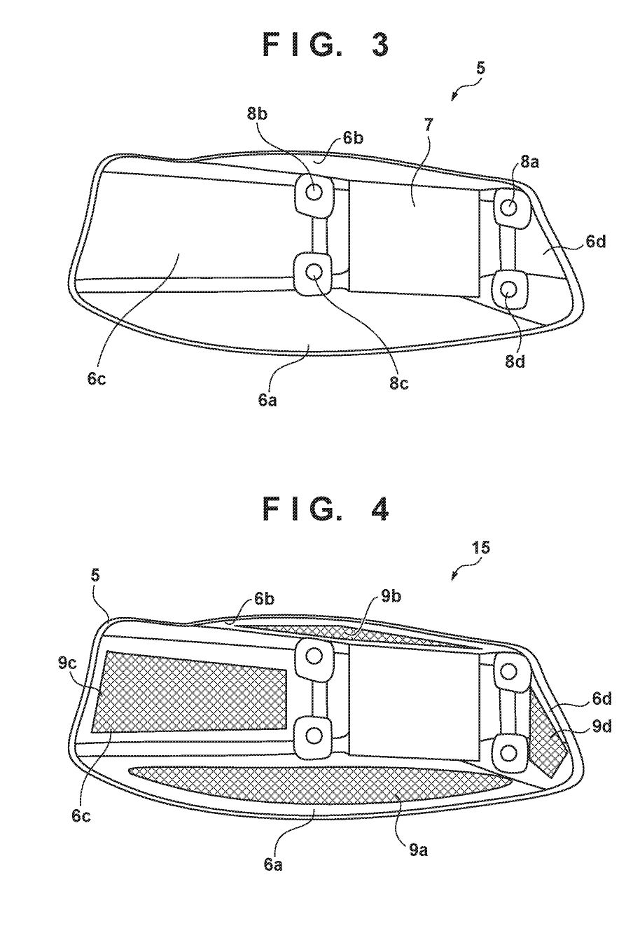

FIG. 3 shows a cover 5 that the main part of the cover member 15. The cover 5 is arranged on the side of the electromagnetic wave output surface of the sensor 2 and formed by a flexible member. The cover 5 is a cover with a tubular or horn shape having an opening portion on the rear end side and an opening portion on the front end side. In general, the opening area of the opening portion of the cover 5 on the front end side is larger than the opening area of the opening portion of the cover 5 on the rear end side. The flexible member is made of, for example, an ethylene-vinylacetate copolymer resin. The ethylene-vinylacetate copolymer resin remains flexible even under a low temperature equal to or less than the freezing point and has excellent weatherability. According to this embodiment, the cover 5 extends from the sensor 2 to the back surface of the bumper and protects the sensor 2 from water and the like.

As shown in FIG. 3, the inner surface of the cover 5 may be formed from a plurality of surfaces. Note that an electromagnetic wave output from the sensor 2 passes the inner surface side of the cover 5. The inner surface of the cover 5 includes at least a bottom surface 6a, a top surface 6b, a first side surface 6c, and a second side surface 6d. As shown in FIGS. 2 and 3, the first side surface 6c extends from the rear end of the cover 5 to the front side in the traveling direction of the vehicle 1. The second side surface 6d extends from the rear end of the cover 5 to the side surface of the vehicle 1. As shown in FIGS. 2 and 3, a length L1 of the first side surface 6c in the direction from the rear end to the front end of the cover 5 is larger than a length L2 of the second side surface 6d in the direction from the rear end to the front end of the cover 5. When a force is applied from the outside of the vehicle to a front bumper 4, a component of the force applied from the front side to the front bumper 4 is often larger than a component of the force applied from a side. To disperse the component of the force applied from the front side to the front bumper 4, the length L1 of the first side surface 6c is larger than the length L2 of the second side surface 6d.

Four insertion holes 8a, 8b, 8c, and 8d are provided at the rear end of the cover 5 on the inner surface side. Four fixing members 12 are inserted into the insertion holes 8a, 8b, 8c, and 8d. In FIG. 2, of the four fixing members 12, only the fixing members 12a and 12b inserted into the insertion holes 8a and 8b are shown.

A sensor hole 7 having a size corresponding to the size of the radio wave output surface of the sensor 2 is provided at the rear end of the cover 5. The sensor hole 7 is a rear end opening portion of the cover 5. The radio wave output surface of the sensor 2 is positioned with respect to the sensor hole 7. That is, the rear end opening portion of the cover 5 is covered with the housing front surface of the sensor 2.

FIG. 4 shows the cover member 15. The cover member 15 is formed by the cover 5 and electromagnetic wave absorbing members 9. An electromagnetic wave absorbing member 9a is fixed to the bottom surface 6a. An electromagnetic wave absorbing member 9b is fixed to the top surface 6b. An electromagnetic wave absorbing member 9c is fixed to the first side surface 6c. An electromagnetic wave absorbing member 9d is fixed to the second side surface 6d. The electromagnetic wave absorbing members 9a, 9b, 9c, and 9d are thus pasted or bonded to the inner surface side of the cover 5 through which an electromagnetic wave output from the sensor 2 passes. As shown in FIG. 4, the cover 5 and each electromagnetic wave absorbing member 9 form a layer structure. The electromagnetic wave absorbing member 9 may extend from the front end to the rear end of the cover 5 in this way. Note that the electromagnetic wave absorbing members 9 may be attached to cover the whole inner surface.

A second/additional cover configured to cover the front end may be fixed to the front end of the cover 5. As shown in FIG. 2, the second/additional cover may be a portion of the bumper of the vehicle 1.

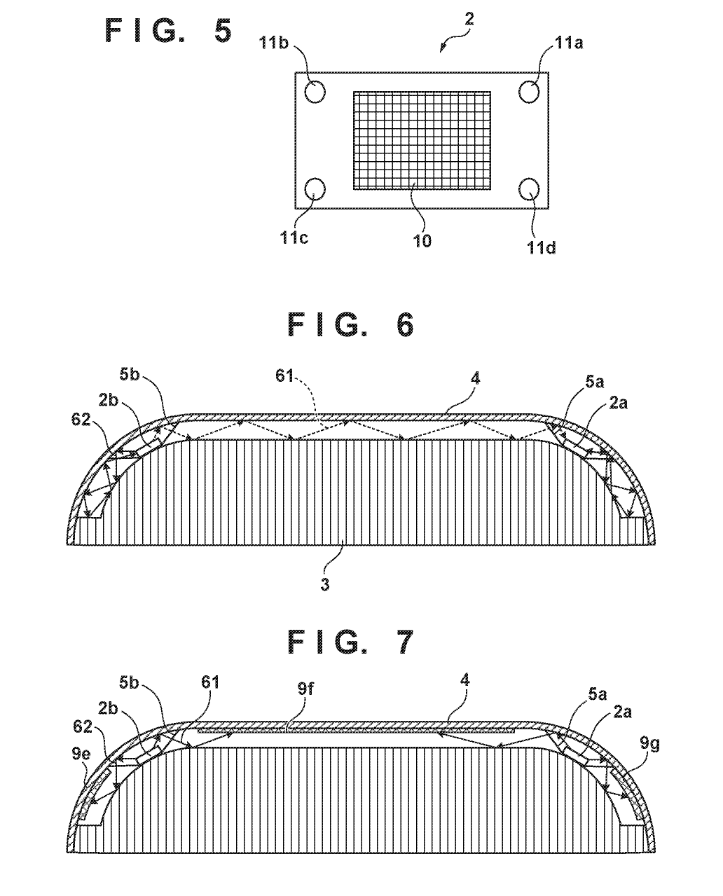

FIG. 5 is a front view of the sensor 2. A radio wave output surface 10 is provided at the center of the sensor 2. An antenna or laser source is provided behind the radio wave output surface 10.

Insertion holes 11a, 11b, 11c, and 11d are provided at the four corners of the front surface of the housing of the sensor 2. The positions and size of the insertion holes 11a, 11b, 11c, and 11d of the sensor 2 match the positions and size of the insertion holes 8a, 8b, 8c, and 8d of the cover 5. This makes it possible to easily position the sensor hole 7 of the cover 5 with respect to the radio wave output surface 10 of the sensor 2. In addition, both the sensor 2 and the cover 5 can be fixed to the vehicle 1 by the four fixing members 12. That is, the sensor assembly can be attached to the vehicle 1 by a small number of parts.

As the electromagnetic wave absorbing member 9, a thin and flexible sheet-shaped electromagnetic wave absorbing member may be employed. For example, a known electromagnetic wave absorbing member as described in Japanese Patent Laid-Open No. 2007-81119 may be employed. The electromagnetic wave absorbing member 9 can usefully be pasted to the inner surface of the cover 5.

The thickness of a dielectric layer included in the electromagnetic wave absorbing member 9 is, for example, ¼ the wavelength of an electromagnetic wave output from the sensor 2. When such a thickness is employed, an electromagnetic wave that arrives from an unintended direction is absorbed, and the influence on the sensor 2 is reduced.

### SUMMARY

According to the first aspect of the present invention, there is provided the cover member 15 configured to protect the sensor 2 that outputs an electromagnetic wave and detects the ambient situation of the vehicle. The cover member 15 includes the cover 5 arranged on the side of the electromagnetic wave output surface of the sensor 2 and formed by a flexible member, and the electromagnetic wave absorbing member 9 attached to the inner surface side of the cover 5 through which the electromagnetic wave output from the sensor 2 passes. The cover 5 and the electromagnetic wave absorbing member 9 form a layer structure. Since the cover 5 and the electromagnetic wave absorbing member 9 form a layer structure, a disturbance wave can efficiently be attenuated, and the accuracy of the sensor 2 configured to detect the ambient situation of the vehicle 1 can be improved. Additionally, since the cover 5 is formed by the flexible member, a cover member that hardly breaks is provided.

The sensor 2 may be provided at at least one corner of the four corners of the vehicle 1. Even in light collision, the four corners of the vehicle 1 can hardly disperse stress by the collision. For this reason, when the sensor 2 arranged at a corner (corner portion) of the vehicle 1 is protected by the cover member 15 mainly made of the flexible cover 5, the sensor 2 hardly breaks. Absorption of an electromagnetic wave serving a disturbance wave can also be implemented by the cover member 15.

The sensor 2 is fixed to the vehicle within the range making a predetermined angle with respect to the traveling direction of the vehicle 1. For example, the angle made by the normal to the electromagnetic wave output surface of the sensor 2 and the traveling direction of the vehicle 1 is an angle from 40° to 80°. To efficiently detect the ambient situation of the vehicle 1, the sensor 2 can be arranged within the predetermined range. In particular, a position that meets the condition allows the ambient situation to be efficiently detected.

As shown in FIG. 4, the electromagnetic wave absorbing member 9 extends from the front end to the rear end of the cover 5. This makes it possible to attenuate unwanted electromagnetic waves that arrive from various directions.

The cover member 15 may further include a cover (front end cover) configured to cover the front end of the cover 5. When the front end opening portion of the cover 5 is covered with the cover, the drip-proof properties in the cover 5 can be improved. Note that the rear end opening portion of the cover 5 is covered with the housing front surface of the sensor 2. The cover that coverts the front end opening portion of the cover 5 may be the bumper of the vehicle 1. This can decrease the number of parts. Note that if the electromagnetic wave is an electromagnetic wave in an optical wavelength range, the cover is formed by a member that readily passes the electromagnetic wave (light).

The cover 5 may be made of an ethylene-vinylacetate copolymer resin. The ethylene-vinylacetate copolymer resin has flexibility. In addition, the ethylene-vinylacetate copolymer resin hardly lowers the flexibility even under a low temperature and has excellent weatherability. Hence, the ethylene-vinylacetate copolymer resin is suitable as the material of the cover 5 that protects the sensor 2 mounted in the vehicle 1.

As shown in FIGS. 3 and 4, the inner surface of the cover 5 may include at least the bottom surface 6a, the top surface 6b, the first side surface 6c, and the second side surface 6d. The first side surface 6c extends from the rear end of the cover 5 to the front side (or the rear side) in the traveling direction of the vehicle 1. The second side surface 6d extends from the rear end of the cover 5 to the side surface of the vehicle 1. The length L1 of the first side surface 6c in the direction from the rear end to the front end of the cover 5 is larger than the length L2 of the second side surface 6d in the direction from the rear end to the front end of the cover 5. The distance from the front bumper or rear bumper of the vehicle 1 to the sensor 2 can thus be ensured. Concerning the sensors 2a and 2b arranged on the side of the front bumper of the vehicle 1, stress from the front side of the vehicle 1 can easily be dispersed. Concerning the sensors 2c and 2d arranged on the side of the rear bumper of the vehicle 1, stress from the rear side of the vehicle 1 can easily be dispersed.

The electromagnetic wave absorbing member 9 may be provided on each of the bottom surface 6a, the top surface 6b, the first side surface 6c, and the second side surface 6d of the cover 5. Note that the disturbance wave arriving direction sometimes depends on the vehicle structure. In this case, the disturbance wave arriving direction may be specified by experiments or the like, and the electromagnetic wave absorbing member 9 may be provided only on part of the inner surface capable of attenuating an electromagnetic wave from the specified arriving direction. For example, the electromagnetic wave absorbing member 9c may be provided only on the first side surface 6c.

The electromagnetic wave absorbing member 9 may be pasted or bonded to the inner surface side of the cover 5. This makes it possible to easily fix the electromagnetic wave absorbing member 9 to the cover 5.

The cover 5 may further include the insertion hole 8 provided at the rear end of the cover 5. The cover 5 and the sensor 2 may be fixed to the vehicle 1 by the fixing member 12 inserted into the insertion hole 8 of the cover 5 and the insertion hole 11 provided in the housing of the sensor 2. The cover 5 and the sensor 2 can thus be fixed to the vehicle 1 together. Since a fixing member for the cover 5 and a fixing member for the sensor 2 need not individually be prepared, the number of fixing members can be decreased. In addition, the cover 5 can easily be positioned with respect to the sensor 2.

The electromagnetic wave may be light. That is, the sensor 2 may be not only a sensor such as a millimeter-wave radar but also a sensor such as a laser scanner.

Note that a sensor assembly including the sensor 2 and the cover member 15 that protects the sensor 2 may be provided.

In FIG. 4, the electromagnetic wave absorbing member 9 is attached to the inner surface side of the cover 5. However, the electromagnetic wave absorbing member 9 may be attached to the outer surface side of the cover 5. From the viewpoint of weatherability, it is advantageous that the electromagnetic wave absorbing member 9 is provided on the inner surface side of the cover 5. An adhesive layer of the electromagnetic wave absorbing member 9 attached to the outer surface side of the cover 5 is stacked on an electromagnetic wave transmission layer. Accordingly, an electromagnetic wave reflecting layer is located on the outermost side of the electromagnetic wave absorbing member 9, and an unintended electromagnetic wave can readily be attenuated.

In the above-described embodiment, the electromagnetic wave absorbing member 9 is provided on the cover 5. However, the electromagnetic wave absorbing member 9 may be provided on the inner surface side of the bumper.

FIG. 6 is a view for explaining multipath propagation that occurs inside the front bumper 4. Of electromagnetic waves output from the sensor 2b, some electromagnetic waves pass through the front bumper 4 and go toward the target, and some are reflected by the inner surface of the front bumper 4. If the electromagnetic wave absorbing member 9 is not provided on the cover 5, some electromagnetic waves 61 and 62 reflected by the inner surface of the front bumper 4 pass through a cover 5b. The electromagnetic wave 61 is repetitively reflected between the inner surface of the front bumper 4 and the structure 3 of the vehicle 1, passes a cover 5a and enters the sensor 2a arranged on the right side of the front of the vehicle 1. This may cause an error in the measurement result of the sensor 2a. Similarly, the electromagnetic wave 62 is reflected by the inner surface of the front bumper 4, and further passes through the cover 5b and goes to the rear side of the vehicle 1. The electromagnetic wave 62 is reflected by the structure 3, propagates to the sensor 2b again, and enters the sensor 2b. This causes an error in the measurement result of the sensor 2b. Such multipath propagation of electromagnetic waves in the bumper can occur for each of the sensors 2a to 2d.

FIG. 7 shows electromagnetic wave absorbing members 9e, 9f, and 9g provided inside the bumper. As shown in FIG. 7, the bumper and the electromagnetic wave absorbing member 9 form a layer structure. Since the bumper is a member that is flexible to some degree, the electromagnetic wave absorbing member 9 can be applied to the bumper as well. In this case, the cover 5 can be formed by a flexible member with low electromagnetic wave absorbing performance. As shown in FIG. 7, in the bumper of the vehicle 1, the electromagnetic wave absorbing members 9e, 9f, and 9g are provided within ranges except the electromagnetic wave irradiation ranges of the sensors 2a and 2b. Note that the bumper covers the covers 5a and 5b. The covers 5a and 5b are formed by members through which electromagnetic waves output from the sensors 2a and 2b pass. The electromagnetic wave 62 output from the sensor 2b passes through the cover 5b and goes to the rear side of the vehicle 1. The electromagnetic wave 62 is absorbed or attenuated by the electromagnetic wave absorbing member 9e. Hence, the radio field intensity of the electromagnetic wave 62 returned to the sensor 2b is low. The electromagnetic wave 61 output from the sensor 2b passes through the cover 5b and goes to the sensor 2a. The electromagnetic wave 61 is absorbed or attenuated by the electromagnetic wave absorbing member 9f. Hence, the radio field intensity (electric field strength) of the electromagnetic wave 61 entering the sensor 2a is low. This also applies to the sensor 2a. Of electromagnetic waves output from the sensor 2a, the electromagnetic wave reflected by the inner surface of the front bumper 4 is absorbed or attenuated by the electromagnetic wave absorbing members 9f and 9g.

Here, the electromagnetic wave absorbing member 9 is provided on the side of the front bumper 4. The electromagnetic wave absorbing member 9 may be provided on the rear bumper as well. This makes it possible to omit the electromagnetic wave absorbing members 9 for the covers 5 of the sensors 2c and 2d. Note that the electromagnetic wave absorbing member 9 may be attached to the structure 3 facing the inner surface of the front bumper 4 or the structure of the vehicle 1 facing the inner surface of the rear bumper. That is, the electromagnetic wave absorbing member 9 is provided on one or both of the inner surface of the bumper and the surface (the surface that reflects an electromagnetic wave) of the vehicle structure facing the inner surface.

What is claimed is:

1. A cover member comprising:
a cover arranged on a side of an electromagnetic wave output surface of a sensor configured to output an electromagnetic wave and detect an ambient situation of a vehicle and formed by a flexible member; and
an electromagnetic wave absorbing member attached to one of a side of an inner surface and a side of an outer surface of the cover through which the electromagnetic wave output from the sensor passes,
wherein the cover and the electromagnetic wave absorbing member form a layer structure.

2. The member according to claim 1, wherein the sensor is provided at at least one corner of four corners of the vehicle.

3. The member according to claim 1, wherein the sensor is fixed to the vehicle within a range making a predetermined angle with respect to a traveling direction of the vehicle.

4. The member according to claim 1, wherein an angle made by a normal to the electromagnetic wave output surface of the sensor and the traveling direction of the vehicle is an angle from 40° to 80°.

5. The member according to claim 1, wherein the electromagnetic wave absorbing member extends from a front end to a rear end of the cover.

6. The member according to claim 1, further comprising a second cover configured to cover the front end of the cover.

7. The member according to claim 6, wherein the second cover comprises a bumper of the vehicle.

8. The member according to claim 1, wherein the cover is made of an ethylene-vinylacetate copolymer resin.

9. The member according to claim 1, wherein an inner surface of the cover includes at least a bottom surface, a top surface, a first side surface, and a second side surface,
the first side surface extends from the rear end of the cover to a front side in the traveling direction of the vehicle,
the second side surface extends from the rear end of the cover to a side surface of the vehicle, and
a length of the first side surface in a direction from the rear end to the front end of the cover is larger than a length of the second side surface in the direction from the rear end to the front end of the cover.

10. The member according to claim 9, wherein the electromagnetic wave absorbing member is provided on each of the bottom surface, the top surface, the first side surface, and the second side surface of the cover.

11. The member according to claim 1, wherein the electromagnetic wave absorbing member is pasted or bonded to a side of the inner surface of the cover.

12. The member according to claim 1, wherein the cover further includes an insertion hole provided at the rear end of the cover, and
the cover and the sensor are fixed to the vehicle by a fixing member inserted into the insertion hole of the cover and an insertion hole provided in a housing of the sensor.

13. The member according to claim 1, wherein the electromagnetic wave is light.

14. A sensor assembly comprising:
a sensor configured to output an electromagnetic wave and detect an ambient situation of a vehicle; and
a cover member configured to protect the sensor,
wherein the cover member comprises:
a cover arranged on a side of an electromagnetic wave output surface of the sensor and formed by a flexible member; and
an electromagnetic wave absorbing member attached to a side of an inner surface of the cover through which the electromagnetic wave output from the sensor passes,
wherein the cover and the electromagnetic wave absorbing member form a layer structure.

15. A cover member comprising:
a cover arranged on a side of an electromagnetic wave output surface of a sensor configured to output an electromagnetic wave and detect an ambient situation of a vehicle and formed by a flexible member; and
an electromagnetic wave absorbing member attached to a range except an irradiation range of the electromagnetic wave in a bumper of the vehicle that covers the cover through which the electromagnetic wave output from the sensor passes,
wherein the bumper and the electromagnetic wave absorbing member form a layer structure.
